(19) United States
(12) Patent Application Publication
(10) Pub. No.: US 2024/0376322 A1
(43) Pub. Date: Nov. 14, 2024

(54) LOW-TEMPERATURE CURE ADHESION PROMOTER AND PRIMER FOR SUBSTRATES

(71) Applicant: HELIOS COATINGS, INC., Canton, OH (US)

(72) Inventors: Konrad Muehlgrabner, Sipbachzell (AT); Wolfgang Scheinecker, Wels (AT); Guenther Bauer, Bavaria (DE); Mark Leininger, Ocean Gate, NJ (US)

(21) Appl. No.: 18/661,064

(22) Filed: May 10, 2024

Related U.S. Application Data
(60) Provisional application No. 63/501,778, filed on May 12, 2023.

(51) Int. Cl. C09D 5/00; C08J 7/04; C08J 7/043; C08J 7/044; C09D 5/24; C09D 7/45; C09D 163/00

(52) U.S. Cl. CPC C09D 5/002; C08J 7/0427; C08J 7/043; C08J 7/044; C09D 5/24; C09D 7/45; C09D 163/00; C08J 2323/00; C08J 2423/30; C08J 2463/00

(57) ABSTRACT

A low-temperature curing adhesion promoter and primer for substrates is disclosed that combines a polyolefin with resins in a water-based coating or in dry-powder coating form. The water-based coating is prepared from mixing a dry solid-powder composition that includes the polyolefin and the resin(s) featuring a hardener/crosslinker with water. The water-based coating is applied to a substrate, such as thermoplastic olefins, to make the substrates conductive for electrostatic painting or further processing.

This application claims priority to and any other benefit of U.S. Provisional Patent Application Ser. No. 63/501,778 filed May 12, 2023, the contents of which are incorporated herein in their entirety by reference.

### FIELD

Disclosed is an adhesion promoter and primer for substrate surfaces that can be cured below 100° C., preferably below 95° C. and most preferably between 90° C. and 80° C. More particularly, the invention relates to a low-temperature cure adhesion promoter and primer that is in the form of a water-based coating or a dry powder coating and applied to substrate surfaces that cure in a range of 80° C. to 100° C.

### BACKGROUND

Coatings are an essential element in the protection of base materials and products (each designated as a “substrate”) from corrosion, etching by acids, oxidation and surface impairment. Coatings, in most cases, also provide a desired look for the substrate using color and/or a smooth or textured surface.

Substrates that can be coated include a wide range of materials used in various industries, such as metals (e.g., aluminum, steel, copper, brass), plastics (e.g., polycarbonate (“PC”), polypropylene (“PP”), acrylics, thermoplastic olefins (“TPO”), sheet molding compound, also known as sheet molding composites (“SMC”), reaction injection molding urethane (“RIM urethane”), polyvinyl chloride (“PVC”), polyethylene terephthalate (“PET”), polycarbonate/polyethylene terephthalate (“PC/PET”), polyamine (“P”), glass, ceramics, wood, even medium-density fiberboard (“MDF”) and composites (e.g., polymer matrix composites (“PMC”), metal matrix composites (“MMC”), ceramic matrix composites (“CMC”), carbon matrix composites (“CAMC”). In addition, substrates used in the electronics industry, such as silicon, can also be coated.

Coatings can be applied either in a wet or dry state. Wet coatings are primarily applied using a solvent based system to enhance the transfer efficiency coverage of the paint on the substrate. However, solvent based coatings include Hazardous Air Pollutants (“HAP's”) as defined, by example, in the list issued by the United States Environmental Protection Agency (“EPA”), Volatile Organic Compounds (“VOCs”) as defined, by example, as those defined by the European Commission on the VOC Solvents Emission Directive 1999/13/EC as “any organic compound as well as a fraction of creosote having a vapor pressure of 0.01 kPa or more at 293.15K” and sometimes materials that include Halogens, such as halogen-containing solvents, like methylene chloride, carbon tetrachloride, chloroform, perchloroethylene, trichlorethylene trichloro trifluoroethane, 1.1.1-trichloroethane and the like, all of which are harmful to the environment and under increasing governmental regulations to be eliminated from use. Generally, halogenated compounds (designated as Halogens in the present specification), include organic molecules which contain at least one halogen atom selected from chlorine, fluorine, bromine and iodine. Halogen astatine is rare and tennessine is not found in nature. Halogens can be used to modify polymers (resins) to produce modified adhesion promoters for plastics made of poly propylene (“PP”) and or polyethylene. Attempts to reduce these toxic substances include water-based liquid coating systems and dry powder coating systems. Unfortunately, most of the current water-based coating systems still include a small percentage of the HAP's and VOC's. Liquid coating systems have an advantage as their resin systems have been developed to reduce their curing temperatures in an attempt to reduce CO² emissions caused by the thermal curing process. Some liquid coating systems can cure within a low temperature range of 80° C. to 90° C. reducing the dependency of the use of fossil fueled energy. Most governments require mandatory remediation of the exhaust of the curing liquid coatings to eliminate HAP's, and VOC emissions. This remediation is accomplished through oxidizers, using one of either a Regenerative Thermal Oxydizer (RTO), Thermal Recuperative Oxidizer (“TRO”) or a Catalytic Recuperative Oxidizer (“CRO”), all of which have high acquisition costs and a high use and cost of natural gas. CRO's operate at temperatures between 315C and 479C while RTO and TRO's use temperatures as high as 900C to eliminate VOCs. Using these copious amounts of natural gas produces significant CO² emissions, often negating the benefits of a reduction of natural gas usage by low temperature curing coatings. A liquid coating system that would eliminate all HAP's, VOC's, Halogens as well as reducing the use of natural gas and its CO² emissions for curing thereby eliminating the need for using oxidizers would be optimum.

Powder coating systems (“powder paints”) were developed to avoid the use of solvents thereby reducing or eliminating HAP's and VOC's. Powder coating is a conventional method of applying a decorative or protective finish to a substrate. The coating is a dry powder that is applied electrostatically to the surface of the substrate and then cured thermally. A wide range of materials can be powder coated, including metals (e.g., steel, aluminum, brass, copper), plastics (e.g., PVC, PC, PP, PC/PET, P), wood and MDF. In addition, substrates used in the electronics industry, such as silicon, can also be coated . . .

Certain substrates show problems with multiple defects and issues if put under high temperature such as creating deformities as well as degassing defects in castings (steel, aluminum, etc.), thermoformed and other plastics and therefore would need a reduced curing temperature to preserve the shape and condition of the substrate. Available powder coatings cure at 100° C. or more. In the market there are currently available a nominal number of powder paints, stating a low thermal curing temperature threshold of 100° C. (see WO2011/138432A1 and WO2017/029350). Most common and commercially marketed as a low cure powder paint usually cures at or above 115° C. Even with this low curing range, however, these powder paints are eliminated from a significant number of heat sensitive substrates, primarily plastics, thus mandating the utilization of a liquid coating, incurring its hazardous emissions.

Certain substrates (such as low surface energy substrates) present complications with paint adhesion that require a modification to or with an adhesion promoting functionality. Powder paints require a conductive substrate or a heated substrate for the powder coating to adhere to the substrate. A significant number of plastic substrates, such as TPO's have a low surface energy and high resistivity that would require an adhesion promoter to allow for a coating, either liquid or powder, to adhere to these plastic substrates. Other substrates need lower curing conditions due to their chemical compositions such as requiring a lower E-module that results in a softer material and therefore are not able to hold or retain its form/shape.

In the instance of TPO and TPO compounded substrates having highly desired properties such as moldability, flexibility, durability, using recycled materials and low cost, have helped TPO gain wide acceptance as the material of choice for automotive fascia, bumpers and other automotive parts such as body panels, dashboards, cup holders, and door coverings to name a few of the many automotive uses. TPO is also utilized as a roofing material, window frames, office furniture and other industrial components. TPO is a blend that includes a thermoplastic olefin (e.g., PP, PE, block copolymer polypropylene), an elastomer (e.g., ethylene propylene rubber, ethylene propylene diene rubber, ethylene-octene, ethylbenzene, styrene ethylene butadiene styrene), and optional fillers (e.g., talc, fiberglass, carbon fiber, calcium carbonate). In addition to being a strong and durable material, TPO is also resistant to ultraviolet (“UV”) radiation and temperature extremes.

The global automotive industry is the largest user of plastics, predominantly TPO, with its use increasing as demand for increased gas efficiency or reducing the weight of hybrid or electric vehicles increases. Demand from auto manufacturers reduction in weight places additional demands on plastic manufacturers to develop lighter plastics. Lighter plastic is developed by increasing the plastic's Melt Flow Index (“MFI”), also known as the plastic's Melt Flow Rate (“MFR”) to be able to meet the mold design. While increasing the MFI helps molding plastics faster, increasing production capabilities while allowing the reduced thickness of the molded part in helping reduce the weight of the part, paint receptibility of the plastic is inversely proportional to the increase in the MFI, making the plastic more difficult to paint as the MFI increases. These new formulations for lighter plastics make the current adhesion promoter technology most difficult to keep up with ultra-low cure coating requirements.

Automotive original equipment manufacturers (“OEMs”) and suppliers of painted parts in certain circumstances are required to use electrostatic spray equipment for the application of coatings. The higher transfer efficiency of electrostatic spray application results in greater coverage of the coatings and less coating overspray causing fewer emissions of VOC's and HAP's. This requires that the substrate surface to be coated has sufficiently low enough surface electrical resistivity to allow the electrostatic process to work. While metals inherently have low surface electrical resistivity, other substrates, such as TPO and other plastics, suffer from a lack of paint-ability due to their low surface energy and/or high surface electrical resistivity. Accordingly, processes have been developed to modify substrates such as TPO to allow them to be painted electrostatically.

To paint substrates having low surface energy and/or high surface electrical resistivity with electrostatic spray equipment, these high surface resistivity materials require (i) the application of a conductive adhesion promoter and primer/coating or (ii) flame treatment followed by the application of a conductive primer prior to applying a decorative coating. Unfortunately, both options include several problems associated with their use.

Conductive adhesion promoters/primers/coatings resolve the problem of paint adhesion to thermoplastic olefin substrates but come with serious environmental and safety issues. Conductive adhesion promoters face compatibility issues between modified polyolefins, which allow for adhesion to TPO, and co-resins, which allow for subsequent layers to adhere to the adhesion promoter/primer. In the present invention, co-resins are also named as resins. Modified polyolefins are typically soluble in hydrocarbon solvents (e.g., toluene, xylene), but are typically not soluble in oxygenated solvents (i.e. solvents whose chemical structure contains carbon atoms, hydrogen atoms and oxygen atoms, such as alcohols, ketones, esters, ethers, glycol ethers and the like, e.g., butyl acetate). Co-resins are typically soluble in oxygenated solvents (e.g., butyl acetate) but are not typically soluble in hydrocarbon solvents (e.g., toluene, xylene). Based on this incompatibility, that is, as used herein, resins and co-resins that cannot be dissolved in the same solvent, the act of mixing, and stabilizing the modified polyolefin and co-resins, has proved to be challenging.

Current commercially available modified polyolefins for use in conductive adhesion promoters include (i) halogenated chlorine-modified polyolefins (also defined as chlorinated polyolefins (“CPO's”) and (ii) maleic anhydride modified polyolefins and (iii) acrylic modified polyolefins. CPO's and acrylic modified polyolefins help resolve the incompatibility between the polyolefin and the co-resins included in an adhesion promoter but come at the expense of gasoline resistance and increased environmental concerns. Halogenated organic compounds, such as CPO's are Persistent Organic Pollutants (“POP's”) that are resistant to environmental degradation through chemical, biological, and photolytic processes reflecting the nonreactivity of the carbon-chlorine bond toward hydrolysis and photolytic degradation. CPO's have high lipid solubility and as such, they bioaccumulate in fatty tissues. For these reasons, non-chlorine modified polyolefins (“non-CPO's”), such as maleic anhydride modified polyolefins, are preferred. In addition to being more environmentally friendly than CPO's, non-CPO's generally provide improved gasoline resistance. However, non-CPO's have even greater incompatibility with co-resins than CPO's and for this reason have found very limited use. Further, the use of modified polyolefins is limited to high molecular weight compounds to meet standards related to gasoline resistance. Copious amounts of hydrocarbon solvents, such as toluene and xylene, are required to dissolve such high molecular weight CPO's or non-CPO's.

Toluene and xylene are VOC's and are on the U.S. Environmental Protection Agency's list of HAP's with toluene and halogens being restricted chemicals within the European Union. Furthermore, both toluene and xylene have high electrical resistivity that results in the buildup of dangerous static charge when dosing to a batch or during spray application. The build-up of static electricity can result in a spark leading to a fire. The situation is made still worse by the fact that toluene has an extremely low flash point (i.e. 4° C.). Moreover, conductive adhesion promoters further require curing at elevated temperatures often at 120° C. and above. In addition to the aforementioned elevated curing temperatures, due to the VOC's and HAP's inherent within these materials, additional energy is consumed through the use of an expensive oxidizer (i.e. a RTO, CRO or TRO) often requiring temperatures between 760° C. and 900° C. to achieve 95% to 99% efficiency producing significant greenhouse gases. Achieving high curing temperatures requires significant energy and disadvantageously increases both the time and cost of producing a cured coating. Based on the problems associated with existing conductive adhesion promoters, a flame treatment of the TPO substrate followed by an application of a conductive primer prior to applying a decorative coating has been developed. By rapidly applying intense heat to a TPO surface, the surface molecular chains are broken, and polar functional groups are added. Flame treatment also burns off dust, fibers, oils and other surface contaminants. However, flame treatment suffers from a lack of robustness and does not make nonconductive TPO substrate conductive, which is necessary so that subsequent layers of coatings may be applied electrostatically. Further, flame treatment requires a large amount of energy and results in the production of greenhouse gases by burning natural gas.

Flame technology utilizes passing a natural gas blue flame over the substrate creating functional groups formed by reactive species such as O² radical-anions, OH-radicals or hydroperoxy radicals created in the flame reacting subsequently with the substrate surface imparting oxygen into the substrate allowing the paint to bond to the oxygen receptors. The increased oxygen surface content is limited to several nanometers below the surface and has a limited increased surface tension time thereby requiring coatings to be applied soon after the application of the flame process. In addition to the significant CO² emissions and costly use of natural gas, the flame technique requires very precise coverage over an inconsistent surface of convex and concave undulations to ensure proper surface preparation. This technique requires significant investment in robotic equipment and continual software engineering as part dimensions and surface features change and equipment wears with each new part dimension. After flame treatment preparation of the substrate, a primer coating is then applied to the substrate.

The benefits of using TPO and other types of substrates are so great that its use is expanding despite the paint ability problems. It is an objective of the present invention to alleviate or overcome one or more of the difficulties related to the prior art. It has been found that polyolefins and co-resins that are incompatible based on their respective solubilities may be compounded together to form a solid-powder composition. The solid powder composition may be applied in the powder form or mixed with water to prepare a water-based coating that includes a polyolefin with a low melt temperature, co-resins with a low cure temperature, hardeners and optionally conductive agents, one of more of wetting agents, pigments, additives, and fillers. The powder composition or water-based coating may be applied to many types of substrates including those having low surface energy, non-conductive surfaces, such as TPO, resin transfer molded substrates and plastics such as reaction injection molding substrates to improve paint adhesion. The water-based coating avoids the use of organic solvents and Halogenated material, and thus provides an option that is more environmentally friendly than existing adhesion promoters, primers and coatings. The composition and method of preparing the solid-powder compositions and the water-based coating do not include the use of environmentally dangerous solvents, Halogens or flame treatment to prepare the substrate surfaces for painting. The compositions and methods of preparing the solid-powder composition involve curing at temperatures below 100° C. and require less energy, time and cost to achieve a cured coating.

This invention provides an optimal low curing temperature liquid water-based coating system and/or a dry powder coating system to pretreat plastics for accepting paint and at the same time providing the primer layer for subsequent base and top coating layers. This invention gives the advantages of no toxicity, no VOC's, no HAP's, reduced CO² emissions and utilizes no Halogens to produce its purpose of creating a receptive and primed substrate. This invention also provides for significant cost reductions through the reduction or elimination of the need for oxidizers, a reduction in processing costs through the elimination of one of the two initial part pretreatment steps through the combined surface pretreatment and application of a prime coating layer in one process.

### SUMMARY

There is disclosed, in a first aspect, a water based coating for application to a substrate, the coating includes water, a polyolefin having a melting temperature below 100° C., a resin having a cure temperature in the range of 80° to 100° C. and/or a melting temperature in the range of 65° to 90° C., a hardener, an optional substrate wetting agent, and an optional conductive agent. In the second aspect, a dry powder coating application to a substrate, the dry powder coating includes a polyolefin having a melting temperature below 100° C., a resin having a cure temperature in the range of 80° to 100° C. and/or a melting temperature in the range of 65° to 90° C., a hardener, an optional substrate wetting agent (such as SURFYNOLI® 104 and others), and an optional conductive agent (such as TUBALL™ Matrix 821 and others).

In an example of aspect 1, the substrate is composed of a material selected from the group consisting of a polymer, metal, carbon fiber and a combination thereof.

In another example of aspect 1, the substrate is selected from the group consisting of a non-conductive, low surface energy substrate, thermoplastic olefin substrate, a resin transfer molded substrate, and a reaction injection molding substrate.

In another example of aspect 1, the substrate wetting agent is present in an amount from 0.1-1.5 weight percent of the water-based coating. A free-flowing powder substrate wetting material, e.g., tetramethyldecynediol gemini surfactant.

In another example of aspect 1, the conductive agent is present in the water-based coating in an amount from 0.1-10 weight percent of the water-based coating.

In another example of aspect 1, the conductive agent comprises single-walled carbon nanotubes.

In another example of aspect 1, the polyolefin is a non-halogen modified polyolefin.

In another example of aspect 1, non-halogen modified polyolefin is a maleic anhydride-modified polyolefin or the polyolefin is an unmodified polyolefin.

In another example of aspect 1, the polyolefin has a melting temperature in the range of 60° C. to 90° C.

In another example of aspect 1, the resin is an epoxy resin.

In another example of aspect 1, the resin has a cure temperature in the range of 80° to 90° C.

In another example of aspect 1, the hardener is an amine-functional compound and/or the hardener has a melting temperature in the range of 65° C. to 90° C.

In another example of aspect 1, the amine-functional compound is selected from the group consisting of a polyamine compound, an aliphatic polyamine compound, and an aromatic amine compound. The hardener may also be a polyanhydride compound.

In another example of aspect 1, a thermoplastic olefin substrate coated with the water-based coating of aspect 1, wherein the coating of the water-based coating has been cured at a temperature in the range of 60° C. to 90° C.

In another example of aspect 1, the water-based coating is not comprised of materials that have been processed through an extrusion process (i.e. a mixture of dry materials), that is used to coat the thermoplastic olefin substrate.

In a second aspect, there is disclosed a dry or wet composition for application to a substrate, that includes a polyolefin having a melting temperature below 100° C., a resin having a cure temperature in the range of 80° to 100° C., a hardener having a melting temperature in the range of 65° C. to 90° C., an optional substrate wetting agent, and an optional conductive agent.

In an example of aspect 2, the substrate is composed of a material selected from the group consisting of a polymer, metal, carbon fiber or a combination thereof.

In another example of aspect 2, the substrate is selected from the group consisting of a non-conductive, low surface energy substrate, thermoplastic olefin substrate, a resin transfer molded substrate, and a reaction injection molding substrate.

In another example of aspect 2, the polyolefin is a non-halogen modified polyolefin.

In another example of aspect 2, the non-halogen modified polyolefin is a maleic anhydride-modified polyolefin.

In another example of aspect 2, the polyolefin has a melting temperature in the range of 60° C. to 90° C.

In another example of aspect 2, the resin is an epoxy resin.

In another example of aspect 2, the resin has a cure temperature in the range of 65° to 97° C.

In another example of aspect 2, the hardener is present in the composition at 12 to 40 weight percent based on the total weight of the composition and the hardener is an amine-functional compound.

In another example of aspect 2, the amine-functional compound is selected from the group consisting of a polyamine compound, an aliphatic polyamine, and an aromatic amine compound. The hardener may also be a polyanhydride compound.

In another example of aspect 2, there is a thermoplastic olefin substrate coated with the dry or wet composition such that the coating of the dry or wet composition has been cured at a temperature in the range of 60° C. to 100° C.

In another example of aspect 2, wherein the dry or wet solid-powder composition coating the thermoplastic olefin is not comprised of materials that have been processed through an extrusion process (i.e. a mixture of dry materials).

In a third aspect, there is disclosed a method for preparing a water-based coating for application to a substrate, the method includes preparing a solid-powder composition comprising a resin having a cure temperature in the range of 80° to 100° C. and a polyolefin having a melting temperature below 100° C.; extruding the solid-powder composition to prepare an extrudate; and combining the extrudate with a hardener and water to prepare a water-based coating.

In an example of aspect 3, the solid-powder composition further includes at least one of a pigment, a flow-control agent, and a degassing agent.

In another example of aspect 3, the method further includes adding a conductive agent to the water-based coating.

In another example of aspect 3, the method further includes milling the extrudate prior to the step of combining the extrudate with water.

In a fourth aspect, there is disclosed a method for preparing a substrate for electrostatic painting, the method includes preparing a solid-powder composition comprising a resin having a cure temperature in the range of 80° to 100° C. and a polyolefin having a melting temperature below 100° C.; extruding the solid-powder composition to prepare an extrudate; combining the extrudate with a hardener and water to prepare a water-based coating; and preparing a coated substrate by applying the water-based coating to the substrate.

In an example of aspect 4, the method further includes curing the coated substrate at a temperature in the range of 60° C. to 100° C.

In another example of aspect 4, the method further includes applying a finishing coat to the coated substrate via electrostatic painting.

In a fifth aspect, there is disclosed a method for preparing a substrate for electrostatic painting, the method including preparing a water-based coating comprising a conductive agent; applying the water-based coating to a substrate to prepare a wetted substrate; preparing a dry, solid-powder composition comprising a resin having a cure temperature in the range of 80° to 100° C., a polyolefin having a melting temperature below 100° C. and a hardener; and applying the dry, solid-powder composition to the wetted substrate.

In an example of aspect 5, the dry, solid-powder composition is prepared as a dry mix without extrusion.

In another example of aspect 5, the method further includes curing the applied dry, solid-powder composition at a temperature in the range of 60° C. to 100° C.

The above aspects (or examples of those aspects) may be provided alone or in combination with any one or more of the examples of that aspect or another aspect discussed above, e.g., the first aspect may be provided alone or in combination with any one or more of the examples of the first aspect, second aspect, third aspect, fourth aspect or fifth aspect as discussed above.

Additional features and advantages will be set forth in the detailed description which follows, and in part will be readily apparent to those skilled in the art from that description or recognized by practicing the embodiments as described herein, including the detailed description which follows:

### DETAILED DESCRIPTION

The terminology as set forth herein is for the description of the embodiments only and should not be construed as limiting the invention as a whole.

Herein, when a range such as 5-25 (or 5 to 25) is given, this means preferably at least 5 and, separately and independently, preferably not more than 25. In an example, such a range defines independently at least 5, and separately and independently, not more than 25.

Disclosed herein is a solid-powder composition that includes incompatible polyolefins (The term “incompatible” as it relates to blends of the polyolefins and resins means that the individual components are not practically soluble within the same type of solvent or water) and resins and the use of the solid-powder composition to prepare a water-based coating, in order to make a substrate, for example a low surface energy, non-conductive substrate surface (e.g., TPO), paintable. The term “non-conductive surface” as it relates to the present disclosure is a surface that has a surface resistivity greater than 10 MΩ (2 (10 meg-ohm as measured by a Multimeter). The term “low surface energy surface” as it relates to the present disclosure is a surface that has a surface energy less than 35 mN/m (Millinewton/meter as measured by a Tensiometer). The compositions and water-based coatings can be used to coat substrates other than low surface energy, non-conductive substrates, for example, substrates can include a polymer, metal, carbon fiber, or a combination thereof. Examples of other suitable substrates are a resin transfer molded substrate, and a reaction injection molding substrate.

Based on this incompatibility, blends of polyolefins and resins begin to separate into distinct layers immediately after being combined in a solvent. This separation results in the mixture being unusable for commercial applications as the mixture must be constantly stirred to keep the components evenly dispersed in the solvent. The disclosed process utilizes extrusion (e.g., melt and mix process) or fine-grinding and mixing to compound the incompatible components (i.e., dry, solid modified polyolefin and resins) into a sufficiently homogeneous and stable solid-powder composition. The resulting solid powder composition is, in certain instances, dispersed in water to prepare a water-based coating, and thus avoids the use of hydrocarbon solvents (e.g., toluene and xylene) and/or oxygenated solvents (e.g., butyl acetate). In other words, the water-based coating is void of hydrocarbon solvents and/or oxygenated solvents.

The dry solid-powder composition includes a combination of a polyolefin, resins, a hardener, and optionally a wetting agent, a conductive agent, a flow control agent, a degassing agent, pigments and/or fillers. The solid-powder composition preferably is curable in the temperature range of 80° C. to 100° C. The solid-powder composition has the following preferred formulation as shown in Table 1. In Table 1, all values are weight percentages based on the total weight of the solid-powder composition. It is to be further understood that a solid-powder composition as herein disclosed need not necessarily draw its entire composition from a single column in Table 1. Such a solid-powder composition may, for example, include one or some component(s) from the “most preferred” column below, other component(s) from the “less preferred” column, and still other component(s) from the “still less preferred” column.

TABLE 1

| | Most Preferred | Less Preferred | Still Less Preferred |
|---|---|---|---|
| Component | Weight Percent | Weight Percent | Weight Percent |
| Resin(s) | 50-60% | 60-87% | 50-97% |
| Polyolefin | 14-16% | 10-30% | 8-50% |
| Pigment | 9-11% | 8-20% | 0-25% |
| Flow control agent | 0.5-1.5% | 0.4-1.7% | 0-2% |
| Degassing agent | 0.25-0.75% | 0.1-1% | 0-2% |
| Fillers | 0-10% | 0-17% | 0-25% |

The solid-powder composition provides the necessary powder composition for powder application to receptive substrates but is also the precursor to the water-based coating that is applied to substrates normally applied to by liquid coatings as well as including the low surface energy, non-conductive substrates, such as TPO. The solid-powder compositions can be stored, for example, at ambient temperature for a period of at least one year. Each of the components from Table 1 above will now be further described:

The solid powder composition comprises resin(s) such as a powder-coating resin and a powder coating crosslinker or hardener. In the present description a hardener is sometimes designated as also a crosslinker. Thus the hardener may be added to the composition separately or as a component of the resin used as a starting material. The selection of the polyolefin and resin(s) to be included in the solid-powder composition is based on the desired properties of the final coating. Such properties may include Tg (softening point), 60° C. pressure washer resistance, climate resistance (e.g., ozone, UV resistance), gasoline resistance and other durability tests as regulations or customers may require (e.g. DIN ISO 16575, ISO 11358-1:2022, Daimler DBL 5415, DIN EN ISO 16925 Version B and Test in Table 24 of this specification). Suitable powder coating resin(s) and powder coating crosslinkers and/or hardeners for use in the resins have melt or softening points between 60° C. and 100° C. In other examples, the powder coating resin(s) and powder coating crosslinker(s) and/or hardener(s) include those that are not compatible with the polyolefin used in the solid powder composition in terms of solubility in a given solvent, as explained above. Suitable powder coating resins include acrylic resins, epoxy resins, amine modified resins, phenolic resins, saturated and unsaturated polyester resins, urea resins, urethane resins, blocked isocyanate resins, and mixtures thereof. Suitable powder coating crosslinkers are accelerator for polyamines, polyamidoamines and the adducts used in conjunction with epoxy resins and acrylic-based oxazoline functional copolymer. Suitable powder coating hardeners are amine-functional hardeners that can include a polyamine compound, an aliphatic polyamine, an aliphatic polyanhydride, an aromatic amine compound or combinations thereof. Suitable powder coating curing agents are also identified as crosslinkers and hardeners. Such powder coating resins, crosslinkers and hardeners include those identified below and as described further in Table 2 below. In Table 2 “MR” denotes melting temperature range, D.S.C. denotes Differential Scanning calorimeter, and EEW denotes Epoxy Equivalent Weight.

TABLE 2

| Product | Type | Producer | Details |
|---|---|---|---|
| D.E.R. 662 ® | EPOXY | Olin | 590-630 (EEW), 610, softening 87-93° C. |
| D.E.R. 692 H ® | EPOXY | Olin | EEW 660-720, EEW 690, softening 89-97° C. |
| D.E.R. 642U-20 ® | EPOXY | Olin | MR 89-97° C. |
| D.E.R. 6225 ® | EPOXY | Olin | MR 87-95° C. |
| D.E.R. 8230W5 ® | EPOXY | Olin | MR 82-92° C. |
| D.E.R. 671 ® | EPOXY | Olin | MR 75-85° C. |
| Araldit GT 7072 ® | EPOXY | Huntsman | 570-595 (EEW), 583, softening 82-90° C. |
| Araldit GT 7071 ® | EPOXY | Huntsman | 385-476 (EEW), 430, 5, MR 65-75° C. |
| Araldit GT 6063 ® | EPOXY | Huntsman | 650-730 (EEW), 690 m, softening 90-97° C. |
| Accelerator 2950 ® | Crosslinker | Huntsman | Amine Value, mg KOH/g 640-700 |
| Accelerator 960-1 ® | Crosslinker | Huntsman | Amine Value, mg KOH/g 561-673 |
| Epocros WS-700 ® | Crosslinker | Nippon | EEW 220 g/eq, Tg 50° C., Oxazoline 4.5 |
| | | Shokubai | mmol/g |
| Aradur 835 ® | Hardener | Huntsman | Calculated with EW 195 g/Eq |
| Additol P-791 ® | Hardener | Allnex | 177 (EW) MR 80-90° C. |
| Aradur 3086 ® | Hardener | Huntsman | Calculated with EW 91 |
| Ancamine 2442 ® | Hardener | Evonik | D.S.C. activation 92>° C. |
| Ancamine 2337S ® | Hardener | Evonik | MR 63-77° C. calculated with EW 195 g/Eq |
| Ancamine 2014FG ® | Hardener | Evonik | MR 97° C. |
| YD-017 ® | EPOXY | Kukdo | 600-700 (EEW) 75-85° C. (MR) |
| KD-211E ® | EPOXY | Kukdo | EEW455-485 MR 65-75° C. |
| KD-242 K ® | EPOXY | Kukdo | EEW 590-640 MR 80-90° C. |
| YD-053 ® | EPOXY | Kukdo | EEW 700-750 MR 85-92° C. |
| KD-9012H ® | EPOXY | Kukdo | EEW 300-400 MR 85-95° C. |
| KD-1014 ® | EPOXY | Kukdo | EEW 320-370 MR 75-90° C. |
| KD-9003 ® | EPOXY | Kukdo | EEW 750-850 MR 75-85° C. |

The inclusion of resins from a group of conventional powder coating resin systems containing an epoxy resin (i.e., polyester/epoxy hybrid) results in incorporating the polyolefin into the crosslinked three-dimensional matrix.

The resins that consist of the combination of one or more resins and one or more crosslinkers and/or hardeners are preferably present in the solid-powder composition in an amount of 50% to 97% by weight of the total composition, more preferably from 60% to 87%, and most preferably from 40% to 50% The crosslinker and/or hardener component of the resins, that can include one or more crosslinkers and hardeners, are present in the solid-powder composition in an amount of 12% to 40% by weight of the total composition, more preferably from 10% to 45%, and most preferably from 5% to 50%.

The polyolefin is provided to promote adhesion of the coating composition to the substrate. Suitable polyolefins for use in the solid-powder composition have melt points or softening points between 60° C. and 100° C., molecular weights between 60,000 to 90,000 g/mole, which include those that are not compatible with the resins used in the solid-powder composition. The polyolefin to be used in the solid-powder composition include homopolymers produced from ethylene, propylene or higher alkylenes, or copolymers from two or more such monomers, unmodified polyolefins, chemically modified polyolefins, such as and maleic anhydride polyolefins. Preferably, such polyolefins include ADVANTIS 510W, CP 730-1®, and CP 164-1® (non-CPO s, commercially available from Eastman); AUROREN AE 20® and AE-301® (non-CPOs, commercially available from Nippon Paper Chemicals); KOATTRO PB M 8510M® and KOATTRO PB M 8911M® (unmodified polyolefins, random copolymers of butene-1 with high ethylene content, commercially available from Lyondell Basel); HARDLEN® series (chlorinated polyolefins modified with maleic anhydride, including HARDLEN CY1321P®, HARDLEN CY-9122P®, and HARDLEN F2P®, commercially available from Toyobo Co., Ltd.), the TOYO TAC® series (maleic anhydride-modified polypropylenes, including TOYO TAC PMA-L®, TOYO TAC PMAKER, TOYO TAC PMA-KH®, and TOYO TAC PMA-T® (commercially available from Toyobo Co., Ltd.); and TRAPYLEN® series (CPO s, including TRAPYLEN 950S®, TRAPYLEN 911S®, TRAPYLEN 139S®, and TRAPYLEN 145S®, commercially available from Tramaco®).

When the polyolefin includes a maleic anhydride polyolefin, a portion of the polyolefin will hydrolyze to the acid form. This acid functionality provides crosslinking between the maleic anhydride polyolefin and functional groups of the resins, such as epoxy groups.

The polyolefin is preferably present in the solid-powder composition in an amount of 8% to 50% by weight of the total composition, more preferably from 10% to 30%, and most preferably from 14% to 30. %

If desired, pigment is provided to introduce color to the coating. This may be a desired feature for either quality control or color enhancement. Suitable pigments to be used in the solid-powder composition include pigment white (e.g. KRONOS 2300®, C.A.S. No. 13463-67-7®, commercially available from KRONOS®), pigment black (e.g. REGAL 400R®, C.A.S. No. 1333-86-4®, commercially available from CABOT®), pigment conductive grade black (e.g. ENSACO 250G®, C.A.S. No. 1333-86-4®, commercially available from TIMCAL®), pigment yellow (e.g. BAYFERROX 3910®, C.A.S. No. 5127400-1®, commercially available from LANXESS®), pigment red (HOSTAPERM D3G70®, commercially available from CLARIANT®), and pigment blue (e.g. HOSTAPERM B2G 03®, commercially available from CLARIANT®).

The pigment is preferably present in the solid-powder composition in an amount of 0% to 25% by weight of the total composition, more preferably from 8% to 20%, and most preferably from 9% to 11% for all colors except black. When black pigment is used it is preferably present in an amount of 0% to 10% by weight of the total composition, more preferably from 0.2% to 5% and most preferably from 0.5% to 2%.

The optional flow control agent is provided to reduce the surface tension of the powder particles, prevent craters in the coating, and to reduce orange peel, if desired. Suitable flow control agents to be used in the solid-powder composition include polyacrylates, polyethers, silicones, and fluorocarbons. Preferably, such flow control agents include MODAFLOW 6000® (poly alkyl acrylate), commercially available from CYTEC®), RESIFLOW PL200® (acrylic copolymer prepared from 2-ethylhexyl acrylate and butyl acrylate, commercially available from ESTRON®), and POWDERMATE 570FL® (amide modified polyether oligomer, commercially available from TROY®). To support adhesion and as the flow of the product is a result not just of the flow property of the coating but also of the size of particles and way of application (water-based coating can work without flow agent) the flow agent can be reduced to very low percentages.

The flow control agent is preferably present in the solid-powder composition in an amount of 0% to 2% by weight of the total composition, more preferably from 0.4% to 1.7%, and most preferably from 0.5% to 1.5%.

The optional degassing agent is provided to lower the surface tension and prevent pin holing in the coatings. Suitable degassing agents to be used in the solid-powder composition include benzoin (C.A.S. No. 119-53-9®, commercially available from ESTRON®), OXYMELT A-2®,-4®,-6®, and -7® (commercially available from ESTRON®), and POWDERADD 9025® (polyolefin wax, commercially available from LUBRIZOL®).

The optional degassing agent is preferably present in the solid-powder composition in an amount of 0% to 2% by weight of the total composition, more preferably from 0.1% to 1%, and most preferably from 0.25% to 1%.

The optional defoaming agent is provided to reduce air captured in a water-based coating due to handling or mixing. Suitable degassing agents to be used in the water-based composition include BYK-1707®, BYK-012® and BYK-1711®, all commercially available from B.Y.K®.

The optional defoaming agent is preferably present in the water-based composition in an amount of 0% to 2% by weight of the total composition, more preferably from 0.1% to 1%, and most preferably from 0.25% to 0.75%.

The hardener/crosslinker/curing agent is preferably a solid aliphatic polyamine adduct that acts as a hardener or crosslinker or curing agent. It can also be an aliphatic polyanhydride. The hardener exhibits high reactivity and hence it is suitable to be used in combination with other hardeners such as Aradur® 835, Aradur®3086 and Accelerator 2950, all available from Huntsman. Accelerator 2950® is a reactive tertiary amine-based accelerator with low plasticizing effect. It is usually used as a co-hardener when used with polyurethane systems, polyamines, polyamidoamines and their adducts. It is good for low temperature and waterborne systems. All three can be used as a hardener, crosslinker or curing agrem. Also, ADDITOL® P 791 (available from Allnex) is a solid aliphatic polyanhydride hardener for use with glycidyl functional group reactions and can be used as a crosslinker/curing agent/hardener according to the present invention.

The optional wetting agent can be a conventional surfactant, (e.g. SURFYNOL® 104®) a nonionic surfactant which is commercially available in different solvents or as a powdered preparation of the surfactant on an inorganic carrier. As a powder, SURFYNOL® 104 S® is a free-flowing powder surfactant providing non-yellowing and degassing for powder coatings. Other wetting agents tested are SURFYNOL® 440®, which is a substrate wetting agent that offers foam control with a moderate solubility in aqueous systems. It is suitable for waterborne coatings and inks. SURFYNOL® AD-01® is a multi-functional gemini surfactant combining dynamic wetting and molecular defoaming. SURFYNOL® AD 01® also acts as a coalescing aid. Each SURFYNOL® product is available from Evonik.

The optional wetting agent is preferably present in an amount of 0% to 1.5% by weight of the total composition, more preferably from 0.1% to 1.0% and most preferably from 0.25% to 0.75%.

The optional conductive agent is provided to improve electrostatic coating efficiency in the coating and thus make a non-conductive substrate conductive for later finishing (i.e. electrostatic painting). Suitable conductive agents to be used in both the solid powder coating and the water-based coating formulations include conductive grade black pigments (ENSACO 250G from TIMCAL) dispersions of carbon nanofibers, single-walled nanotubes, multi-walled carbon nanotubes, and mixtures thereof. Preferably, such conductive agents include carbon nanotubes, such as TUBALL™ MATRIX 821 concentrate by OCSiAl. TUBALL™ MATRIX 821 was tested and is recommended at a dosage rate of 0.2% wt to enable surface resistivity of 106 ohm/sq. Uniform distribution of TUBALL™ COAT E, by OCSiAL, in the target formulation also enhances electrical conductivity. It is preferred in the water-based coating formulation that TUBALL™ COAT E H²O 0.4% SDBS by OCSiAL, be used, mixed with the standard polymer in powder form to prepare conductive rotational molded polyethylene (PE) parts.

The conductive agent is preferably present in the solid powder coating and the water-based coating formulations in an amount of 0% to 10% by weight of the total composition, more preferably from 3% to 8% and most preferably from 4% to 6%. Optionally, the conductive agent is present in the water-based coating in an amount of at least 0.1%, 0.2%, 0.4%, 0.6%, 0.8%, 1%, 2%, 3%, 4%, 5%, 6%, 8% or 10% by weight of the total composition. Optionally, the conductive agent is present in the water-based coating in an amount not greater than 15%, 10%, 9%, 8%, 7%, 6%, 5%, 4%, 3%, or 2% by weight of the total composition.

To prepare the solid-powder composition, each component is weighed out and mixed. For example, the components can be weighed out on a lab scale (e.g. Mettler Toledo DSC 822E) and mixed mechanically by a standard mechanical mixer (e.g. Prism or MIXACO).

After the initial mixing step, the mixture is passed through an extruder (e.g. Copirion SK 25 double barrel extruder) (method1). The extrusion process heats the mixture to a temperature at least 1° C. above the melting temperatures of the polyolefin and the resins. The polyolefin and the resins are blended in the extruder, and the non-melting ingredient (i.e., pigment) is de-agglomerated and evenly distributed in the mixture. Residence time in the extruder is kept to a minimum to prevent premature crosslinking of the co-resins. For example, the residence time in the extruder may be less than or equal to 30 seconds. This mixture does not contain the hardener as it would result in the extruder being blocked and unable to work as the curing temperature of the system could be below the temperature inside the extruder.

Following the extrusion process, the extrudate is cooled. For example, the extrudate may be passed through chiller rollers (BBBA cooler). This cooling prevents chemical crosslinking from occurring between the components in the extrudate. The extrudate is then broken down into smaller pieces or chips that can be stored until ready for use in further processing steps. For example, the extrudate may be run through a kibbler to produce smaller pieces that are about 2 cm-wide×2 cm-long×1 mm thick. Based on the nature of the components used in the mixture, the extrusion process may be repeated, wherein the smaller pieces are passed through the extruder one or more additional times for further compounding.

After the extrudate has been cooled and broken into smaller pieces, the particle size of the composition is reduced with a grinding system (e.g., Neuman & Esser ICM 2.4 lab mill). to meet the development requirements (D50-35 μm). Particle size is measured with e.g., Malvern Mastersizer by laser diffraction. The resulting solid-powder composition may be stored until ready for later use.

A water-based pre-mixture is prepared by blending the solid-powder composition in water as described below. Optionally, the water used to blend the solid-powder composition is deionized or reverse osmosis (“RO”) water. The water-based pre-mixture has the following preferred formulation as shown in Table 3. In Table 3, all values are weight percentages. It is to be further understood that the water-based pre-mixture as herein disclosed need not necessarily draw its entire composition from a single column in Table 1. Such a water-based premixture may, for example, include one or some component(s) from the “most preferred” column below, other component(s) from the “less preferred” column, and still other component(s) from the “still less preferred” column.

TABLE 3

| | Most Preferred | Less Preferred | Still Less Preferred |
|---|---|---|---|
| Component | Weight Percent | Weight Percent | Weight Percent |
| Water | 70-85% | 70-90% | 50-95% |
| Formulation Table 1 or 6 | 15-30% | 10-30% | 5-50% |

The water-based pre-mixture is prepared by mixing the solid-powder composition with water and the hardener that is pre-ground and similar in particle size to the rest of the formulation. The components may be mixed mechanically by a standard mechanical mixer, a paint shaker, a high-speed dissolver using a high-shear blade, or other conventional mixing methods. Optionally, the components may be mixed by a vertical wet mill or a horizontal wet mill. Optionally, the solid powder components can be ground in an opposed jet mill to reduce the particle size of the powder coating formulation in advance reducing the time of grinding within the wet mill. Too much mechanical stress in the mill can result in unfavorable behavior in terms of curing.

The particle size of the solid-powder composition within the water-based premixture is then reduced by milling, such that the particles have a preferable mean value of 3 micrometers and a distribution of 2 to 5 micrometers (measured by grinder meter BYK). Optionally, the solid-powder composition will be jet-milled in advance. Particles of this size will remain free-floating in the water without further separation and are therefore preferred according to the invention. The water-based premixture remains stable when stored at room temperature.

A water-based coating is prepared by combining the water-based premixture with a substrate wetting agent and optionally, a conductive agent. Optionally, the water-based coating may additionally include a viscosity-modifying agent and/or an anti-settling agent. The water-based coating has the following preferred formulation as shown in Table 4. In Table 4, all values are weight percentages based on the total composition. Like the powder composition, the water-based coating preferably is curable in the temperature range of 80° C. to 100° C. It is to be further understood that the water-based coating as herein disclosed need not necessarily draw its entire composition from a single column in Table 1. Such a water-based coating may, for example, include one or some component(s) from the “most preferred” column below, other component(s) from the “less preferred” column, and still other component(s) from the “still less preferred” column.

TABLE 4

| | Most Preferred | Less Preferred | Still Less Preferred |
|---|---|---|---|
| Component | Weight Percent | Weight Percent | Weight Percent |
| Water-based | 93-96% | 91-97% | 88-98% |
| premixture | | | |
| Substrate wetting | 0.25-0.75% | 0.1-1% | 0-1.5% |
| agent | | | |
| Conductive agent | 4-6% | 3-8% | 0-10% |
| Viscosity | 0-2% | 0-3% | 0-4% |
| modifying agent | | | |
| Anti-settling agent | 0-0.5% | 0-1% | 0-2% |
| Defoaming agent | 0-0.5% | 0-1% | 0-2% |

The water-based coating is prepared by blending the water-based premixture with a substrate wetting agent, an optional conductive agent, an optional viscosity-modifying agent, and an optional anti-settling agent. The components may be blended mechanically by a standard mechanical mixer, a high-speed dissolver using a low-shear blade, or other conventional mixing methods. The water-based coating can be applied to any substrate surface including a low surface energy, nonconductive substrate (e.g., TPO substrate) so that subsequent paint layers (e.g., primers, base coat or topcoats, depending on the use of the coating as either an adhesion promoter, primer or coating) will adhere to the substrate or coating and so that the subsequent paint layers can be applied using electrostatic spraying applications. Each of the non-Water-based premixture components from Table 4 above will now be further described.

The optional substrate wetting agent is provided to improve wetting and reduce surface tension for the coating. Suitable substrate wetting agents to be used in the water-based coating include silicone surfactants, polyether-modified siloxanes, and acetylenic surfactants. Preferably, such substrate wetting agents include BYK 3450® (silicone surfactant, commercially available from B.Y.K.) and SURFYNOL 440® or SURFYNOL ADO1® or SURFYNOL 104S® (ethoxylated acetylenic diol, commercially available from EVONIK®).

The substrate wetting agent is preferably present in the water-based coating in an amount of 0% to 1.5% by weight of the total composition, more preferably from 0.1% to 1%, and most preferably from 0.25% to 0.75%.

The optional conductive agent is provided to improve electrostatic coating efficiency in the water-based coating and thus make a non-conductive substrate or coating conductive for later finishing (i.e., electrostatic painting). Suitable conductive agents to be used in the water-based coating include conductive grade black pigments, dispersions of carbon nanofibers, single-walled carbon nanotubes, multi-walled carbon nanotubes, and mixtures thereof. Preferably, such conductive agents include TUBALL COAT_E H₂O 0.4%® (water-based dispersion of single-walled carbon nanotubes, commercially available from OCSiAl®) and ENSACO 250G® (conductive carbon black commercially available from TIMCAL).

The conductive agent is preferably present in the water-based coating in an amount of 0% to 10% by weight of the total composition, more preferably from 3% to 8%, and most preferably from 4% to 6%. Optionally, the conductive agent is present in the water-based coating in an amount of at least 0.1% to 10% by weight of the total composition. Optionally, the conductive agent is present in the water-based coating in an amount not greater than 15%, to 2% by weight of the total composition.

The optional viscosity-modifying agent is provided to improve anti-sagging and anti-settling properties in the coatings. Suitable viscosity-modifying agents to be used in the water-based coating include, for example, modified ureas, RHEOBYK-420® (solution of a modified urea, commercially available from B.Y.K.), and ACRYSOL RM8® (hydrophobically modified ethoxylated urethane, commercially available from DOW).

The optional viscosity-modifying agent is preferably present in the water-based coating in an amount of 0% to 4% by weight of the total composition, more preferably from 0% to 3%, and most preferably from 0% to 2%.

The optional anti-settling agent is provided to increase the viscosity of the coatings if desired. Suitable anti-settling agents to be used in the water-based coating include ANTI-TERRA 250® (alkylol ammonium salt of a higher molecular weight acidic polymer, commercially available from B.Y.K.) and TAMOL SN® (neutral sodium salt of a condensed arylsulfonic acid, commercially available from DOW).

The anti-settling agent is preferably present in the water-based coating in an amount of 0% to 2% by weight of the total composition, more preferably from 0% to 1%, and most preferably from 0% to 0.5%.

The optional defoaming (anti-foaming) agent is provided to improve the coatings' anti-foaming properties, if desired. Suitable anti-foaming agents to be used in the water-based coating include, for example, BYK-1707®, commercially available from B.Y.K.).

The anti-foaming agent is preferably present in the water-based coating in an amount of 0% to 2% by weight of the total composition, more preferably from 0% to 1%, and most preferably from 0% to 0.5%.

Method 2 abstains from using an extruder to create the water-based coating. This Method 2 uses an impact classifier mill (ICM 2.4 from Neuman & Esser) and or a jet mill (NOLL Grinding) to reduce the fine ground powder components according to particle sizes of a mean value of 3 micrometers and a distribution of 2 to 5 micrometers or to any other particle size required by requested results from customers. The water-based coating is further mixed with the named components according to Table 4.

The water-based coating is applied to substrates including low surface energy, non-conductive substrates by any conventional method, including dipping, brushing, and spraying (SAMES HVOP). For example, a standard spray gun for liquid paint may be used to apply the water-based coating to the non-conductive substrate (e.g., TPO).

Other suitable non-conductive substrates for use with the water-based coating compositions disclosed herein include plastic substrates, such as any thermoplastic or thermosetting nonconductive substrates. For example, other suitable substrates include polycarbonate, polyurethane, thermoplastic polyurethane, acrylonitrile butadiene styrene (“ABS”), thermoplastic elastomer, and thermoset polyester, among others. Transfer efficiency when spraying the water-based coating is achieved by the same means that applies to conventional liquid adhesion promoters, i.e. the droplets of the material being sprayed are wet and stick to the substrate when coming into contact with the substrate.

Once applied to the substrate including a low surface energy, non-conductive substrate, the water-based coating is allowed to cure or flash (an expedited process of allowing the just sprayed coating to create a skin, though not yet fully cured, to the allow for additional coatings to be applied) at ambient or elevated temperature, based on the materials selected for the coating. The curing/flash temperature and curing/flash time is sufficient to dry the coating to a film, and are based on the temperature, relative humidity, and velocity of the air moving over the coated substrate, as well as the sensitivity of the selected subsequent coatings to any remaining water. The flash times and flash temperatures are substantially the same as for water-borne base coats prior to applying solvent-borne clear coats, which is a practice widely known and understood within the industry.

The coated substrate is then allowed to cool and is ready for application of additional coatings and/or finishing layers, if desired. The coated substrate may be electrostatically painted with conventional topcoats or other liquid or powder coatings. For example, a finishing layer may be applied via 1K/1K or 1K/2K painting. Following application of the final coating, the coating is allowed to cure or flash at ambient or elevated temperature before being cooled to room temperature.

In an alternative embodiment, a solid-powder composition is prepared as described above. However, rather than being added to water in order to prepare a water-based coating, the solid-powder composition is applied to a substrate including a low surface energy, non-conductive substrate that has been wetted with a water-based coating that can but does not have to include a conductive agent or other additive(s) to make the water wet the surface (e.g. wetting agent, rheological agent). In this embodiment, the water or water-based coating is applied to the substrate including a low surface energy, non-conductive substrate (e.g., TPO substrate) in order to make the substrate conductive and wetted. The solid-powder composition is then able to be applied directly to the wetted substrate, including a low-surface energy, non-conductive substrate (Method 3).

In the alternative embodiment, the solid-powder composition includes a combination of a polyolefin, resin(s), pigment, a flow control agent, and a degassing agent. The solid-powder composition has the preferred formulation as shown in Table 1. In Table 1, all values are weight percentages. It is to be further understood that the solid-powder composition as herein disclosed need not necessarily draw its entire composition from a single column in Table 1. Such a solid-powder composition may, for example, include one or some component(s) from the “most preferred” column below, other component(s) from the “less preferred” column, and still other component(s) from the “still less preferred” column. The amount of each component in the solid-powder composition for the alternative embodiment is the same as the amount of each component discussed previously for the first embodiment.

The solid-powder compositions can be stored at ambient temperature for a period of time, for example at least one year. Each of the components from Table 1 is the same as described above. Each component is weighed out and mixed to prepare the solid-powder composition. For example, a standard mechanical mixer (Prism Mixer) may mix the components mechanically.

After the initial mixing step, the mixture is passed through an extruder (Method 1) or through an impact classifier mill or a jet mill (Method 2). The extrusion process heats the mixture to a temperature above the melting temperatures of the polyolefin and the resin(s). The polyolefin and the resin(s) are blended in the extruder and the non-melting ingredient (e.g., pigment) is de-agglomerated and evenly distributed in the mixture. Residence time in the extruder is kept to a minimum to prevent premature crosslinking of the co-resins. For example, the residence time in the extruder may be less than or equal to 30 seconds.

Following the extrusion process (Method 1), the extrudate is cooled. For example, the extrudate may be passed through chiller rollers (BBBA Cooler). This cooling prevents chemical crosslinking from occurring between the components in the extrudate. The extrudate is then broken down into smaller pieces or chips that can be stored until ready for use in further processing steps. For example, the extrudate may be run through a kibbler to produce smaller pieces that are about 2 cm wide×2 cm long×1 mm thick. Based on the nature of the components used in the mixture, the extrusion process may be repeated, wherein the smaller pieces are passed through the extruder one or more additional times for further compounding.

After the extrudate has been cooled and broken into smaller pieces, the particle size of the composition is reduced with a grinding system (e.g., Neuman & Esser ICM 2.4 lab mill). Particle size is measured with e.g., Malvern Mastersizer. The resulting solid-powder composition may be stored until ready for later use.

Based on the alternative embodiment, the water-based coating is applied to the substrate, including a non-conductive substrate before the solid-powder composition in order to make the substrate conductive and wetted. The water-based coating has the following preferred formulation, as shown in Table 5. In Table 5, all values are weight percentages based on the total composition. It is to be further understood that the water-based coating as herein disclosed need not necessarily draw its entire composition from a single column in Table 5. Such a water-based coating may, for example, include one or some component(s) from the “most preferred” column below, other component(s) from the “less preferred” column, and still other component(s) from the “still less preferred” column. Optionally, the amount of each component in the water-based coating (i.e. water, the substrate wetting agent, the conductive agent, the viscosity-modifying agent, and the anti-settling agent) for the alternative embodiment is the same as the amount of each component discussed previously for the first embodiment.

TABLE 5

| | Most Preferred | Less Preferred | Still Less Preferred |
|---|---|---|---|
| Component | Weight Percent | Weight Percent | Weight Percent |
| Water | 93-96% | 91-97% | 88-98% |
| Substrate wetting | 0.25-0.75% | 0.1-1% | 0-1.5% |
| agent | | | |
| Conductive agent | 4-6% | 3-8% | 0.1-10% |
| Viscosity | 0-2% | 0-3% | 0-4% |
| modifying agent | | | |
| Anti-settling agent | 0-0.5% | 0-1% | 0-2% |
| Anti-foaming | 0-0.5% | 0-1% | 0-2% |
| agent | | | |

The water-based coating is prepared by mixing the optional substrate wetting agent, the conductive agent, and the optional viscosity-modifying agent and optional anti-settling agent with water. The components may be mixed mechanically by a standard mechanical mixer, a paint shaker, a high-speed dissolver using a high-shear blade, or other conventional mixing methods. Optionally, the components may be mixed by a vertical or horizontal wet mill.

The water-based coating is then applied to a substrate including a low surface energy which is non-conductive substrate (e.g., TPO). For example, the water-based coating may be sprayed with a standard spray gun used for liquid paint in a thin layer onto the low surface energy, non-conductive substrate. In another example, the low surface energy, non-conductive substrate may be dipped into the water-based coating, which permits applying the water-based coating to complex, three-dimensional shaped substrates that may be difficult to coat with a liquid spray apparatus. Regardless of how it is applied, the water-based coating adheres to the substrate, including a low surface energy, non-conductive substrate because it is wet and creates a thin film on top of the substrate, and thus allows for further painting applications.

Following application of the water-based coating to the substrate, including a low surface energy, non-conductive substrate, the substrate is wetted with DI or RO water, and the solid-powder composition is applied to the substrate using conventional powder coating equipment. The solid-powder composition adheres to the wetted substrate and is then allowed to cure or flash at ambient or elevated temperature, based on the materials selected for the coating. The curing/flash temperature and curing/flash time is sufficient to dry the coating to a film, and are based on the temperature, relative humidity, and velocity of the air moving over the coated substrate, as well as the sensitivity of the selected subsequent coatings to any remaining water. The flash times and flash temperatures are substantially the same as for water-borne base coats prior to applying solvent-borne clear coats, which is a practice widely known and understood within the automotive industry.

The coated substrate is then allowed to cool and is ready for application of additional coatings and/or finishing layers. Because the coated substrate is now electrically conductive due to the application of the conductive agent in the water-based coating, the coated substrate may be electrostatically painted with conventional topcoats or other liquid or powder coatings. For example, a finishing layer may be applied via 1K/1K or 1K/2K painting. Following application of the final coating, the coating is allowed to cure or flash at ambient or elevated temperature before being cooled to room temperature.

### EXAMPLES

The examples in Table 6 further illustrate various aspects of the disclosed solid-powder composition and its use in preparing water-based coating for application to a low surface energy, non-conductive surface. In the following examples, all composition data are given as weight percentages for the specified component based on the total composition for each example. The coatings prepared in the examples were tested for the percent retention in gasoline immersion tests as described herein.

### Example 1-Preparation of Solid-Powder Composition for Use in the Water-Based Coating

The following solid-powder composition in Table 6 was prepared. All amounts are in weight percent based on the total solid-powder composition weight.

TABLE 6

| Ingredient | | Weight percent |
|---|---|---|
| Araldit GT 7071 ® | Resin (epoxy) | 41.8% |
| Aradur 835 ® | Hardener | 7.4% |
| Additol P791 ® | Hardener | 24.7% |
| Benzoin ® | Degassing agent | 0.8% |
| Resiflow PL 200 ® | Flow agent | 0.8% |
| Kronos 2300 ® | Pigment white | 4.12% |
| Carbon Black FW 2 ® | Pigment black | 0.16% |
| PMA-L ® | Polyolefin | 20% |
| | Total | 100% |

The ingredients in Table 6 were dry mixed with a mechanical mixer (MIXACO machine) in order to prepare a solid-powder composition. The solid-powder composition was then melt-mixed by passing through a twin-screw extruder having a length to diameter ratio of at least 19:1 (Method 1) or fine-ground by a jet mill (Method 2).

Method 1: The compounding zone temperature was maintained between 85° C. and 115° C. and the feeder rate was maintained to produce a torque between 60% and 90%. The resulting extrudate was then pressed into a sheet and cooled by chiller rolls. The resulting extrudate sheet was then crushed into chips by a kibbler. The chips were then passed through an air classifying mill to achieve a particle size of about 30 μm or 2-5 μm achieved by Method 2 below, which were then passed through a vibratory tray sieve to remove any oversized particles.

Method 2: The chips of Method 1 are processed with a jet mill to prepare particles having a size in the range of 2-5 μm. Due to the flexible components within the powder formulation an opposed jet mill is preferred to produce suitable particle size and to keep the temperature below the product Tg (<35° C.) so that the dry blend does not melt or cure during milling.

### Example 2-Preparation of Water-Based Pre-Mixture

The following water-based pre-mixture in Table 7 was prepared using solid-powder composition of Example 1. All amounts are in weight percent based on the total water-based pre-mixture weight.

TABLE 7

| Ingredient | Weight Percent |
|---|---|
| Solid-powder composition of Example 1 | 30% |
| Deionized or RO water | 70% |
| Total | 100% |

The water-based pre-mixture was prepared by adding the solid-powder composition of Example 1 to deionized or RO water while mixing in a high-speed disperser fitted with a high-shear blade. The water-based pre-mixture was then passed through a horizontal bead mill (Dispermat SL-250-C1) to produce the water-based premixture having a mean particle size of approximately 3 μm determined by a Malvern Mastersizer 3000 particle analyzer.

### Example 3-Preparation of Water-Based Coating

The following water-based coating in Table 8 was prepared. All amounts are in weight percent based on the total water-based coating weight.

TABLE 8

| Ingredient | Product | Weight percent |
|---|---|---|
| Water based pre-mixture | As prepared | 98.9% |
| from Table 7 | internally | |
| Substrate wetting agent | Surfynol 104S ® | 1.0% |
| Conductive agent | Tuball Coat_E | 0.1% |
| | H200.4 ® | |
| | Total | 100% |

The water-based coating was prepared by adding a substrate wetting agent (Surfynol 104S®) and the conductive agent to the water-based pre-mixture.

### Example 4-Application of Water-Based Coating to Low Surface Energy, Non-Conductive Substrate

As prepared in Example 3, the water-based coating was applied with a standard spray gun (SATA minijet×3000B) in one coat to achieve a dry film thickness of 3-5 μm, determined by a Malvern Mastersizer 3000 particle analyzer, onto a low surface energy, non-conductive TPO substrate. The coated substrate was then air flashed at room temperature for 10 minutes and baked at 90° C. (194° F.). 1 K Hydro Iridium silver (Iridiumsilber) basecoat and a 2 K solvent clearcoat were applied over the dry film achieved with the application of the water-based coating. The basecoat thickness was approximately 8-12 μm as determined by a Malvern Mastersizer 3000 particle analyzer, and the clearcoat thickness was about 30-40 μm determined by a Malvern Mastersizer 3000 particle analyzer. The basecoat was cured for 15 minutes at 80° C. and clearcoat was cured for 30 minutes at 80° C.

The prepared substrate having the overlying film formed by the water-based coating has its surface cross-hatched according to ASTM D6677 to investigate adhesion of the film to the substrate surface.

The coated TPO substrates of Example 4 was subjected to BMW steam jet test (60° C./65 bar/60 seconds/13 cm distance) with no delamination per BMW specifications requiring less than 90% smaller than 1 mm (DBL5415).

Samples 87-93 and samples 100-106 were further submitted for testing according BMW steam jet test with the results presented in Table 9 below. Table 9 contains multiple trials of powder formulations that were developed, according to DIN EN ISO 2409, maximum value of 1 results in passing test. The difference in the formulation is that different substrates may require different speed of cure, Tg, or other properties that can be achieved with different accelerators/hardeners. As we have an epoxy system the products called “Accelerator 2950CH®” and “Accelerator 960-1®”, commercially available from Huntsman are Amine Adducts and can be utilized as hardeners as well as accelerators. Additionally, EPOCROSWS-700® from Sumitomo was used to accelerate cure time. The ability to achieve proper adhesion while fully satisfying testing standards while achieving low temperature cure with a solvent free coating system did not allow for any comparison to any other materials in our test as there were no comparable materials to test against.

TABLE 9

| Ingredient | | 87 | 88 | 89 | 90 | 91 | 92 | 93 | 100 |
|---|---|---|---|---|---|---|---|---|---|
| Water | | 36.5 | 36.5 | 33.5 | 33.5 | 40.5 | 28.5 | 28.5 | 36.5 |
| Advantis 510W | modified Polyolefine | 30 | 30 | 30 | 30 | 30 | 35 | 35 | 30 |
| | (maleic acid anhydrid) | | | | | | | | |
| Trapylen 9600 W | acrylicmodified | | | | | | | | |
| | polypropylen | | | | | | | | |
| Accelerator 2950 CH | hardener | 7 | 7 | 7 | 7 | | 7 | 7 | 7 |
| Surfynol 104S | wetting agent | 1.5 | 1.5 | 1.5 | 1.5 | 1.5 | 1.5 | 1.5 | 1.5 |
| Byk 3941P | adhesion promoter | | | 3 | 3 | 3 | 3 | 3 | |
| | standard | | | | | | | | |
| SLD-125/72 | SOLUTION-Lab Dev. | 25 | | | | | | 25 | |
| | Version 125 | | | | | | | | |
| SLD-125/105 | | | 25 | 25 | 25 | 25 | 25 | | 25 |
| SLD-125/116 | | | | | | | | | |
| SLD-125/117 | | | | | | | | | |
| Sumitomo/Epocros | hardener | | | | | | | | |
| WS-700 | | | | | | | | | |
| | | 100 | 100 | 100 | 100 | 100 | 100 | 100 | 100 |

| | | | | | | | | |
|---|---|---|---|---|---|---|---|---|
| Testing cross hatch DIN EN ISO 2409 - max | nOK | OK | OK | nOK | OK | nOK | nOK | OK |
| value 1 is OK = okay 2 and higher is nOK (not okay) | | | | | | | | |
| Testing BMW steam jet (60° C./65 bar/60 sec/13 cm) --> | nOK | OK | OK | nOK | OK | nOK | nOK | OK |
| delamination width (mm) - for BMW spec. 90% smaller 1 mm | | | | | | | | |

| Ingredient | | 101 | 102 | 103 | 104 | 105 | 106 |
|---|---|---|---|---|---|---|---|
| Water | | 31.5 | 31.5 | 31.5 | 21.5 | 56.5 | 31.5 |
| Advantis 510W | modified Polyolefine | 35 | 35 | 35 | 35 | | |
| | (maleic acid anhydrid) | | | | | | |
| Trapylen 9600 W | acrylicmodified | | | | | 10 | 35 |
| | polypropylen | | | | | | |
| Accelerator 2950 CH | hardener | 7 | 7 | 7 | 7 | 7 | 7 |
| Surfynol 104S | wetting agent | 1.5 | 1.5 | 1.5 | 1.5 | 1.5 | 1.5 |
| Byk 3941P | adhesion promoter | | | | | | |
| | standard | | | | | | |
| SLD-125/72 | SOLUTION-Lab Dev. | 25 | | | 25 | 25 | 25 |
| | Version 125 | | | | | | |
| SLD-125/105 | | | | | | | |
| SLD-125/116 | | | 25 | | | | |
| SLD-125/117 | | | | 25 | | | |
| Sumitomo/Epocros | hardener | | | | 10 | | |
| WS-700 | | | | | | | |
| | | 100 | 100 | 100 | 100 | 100 | 100 |

| | | | | | |
|---|---|---|---|---|---|
| Testing cross hatch DIN EN ISO 2409 - max | OK | nOK | OK | OK | OK |
| value 1 is OK = okay 2 and higher is nOK (not okay) | | | | | |
| Testing BMW steam jet (60° C./65 bar/60 sec/13 cm) --> | OK | nOK | OK | OK | OK |
| delamination width (mm) - for BMW spec. 90% smaller 1 mm | | | | | |

| SLD125 = SOL - LAB - | | | | | | |
|---|---|---|---|---|---|---|
| DEVELOPMENT 125/Versions | | | | | | |
| 72/105/116/117 as used in SLD 131 | | | | | | |
| | | NEX | NEX | NEX | EX/NEX | EX/NEX |
| Ingredient | | 72 | 73 | 105 | 116 | 117 |
| Araldit GT 7071 | Epoxy/resin (co-resin) | 53.47 | | 50.50 | 50.80 | 50.80 |
| D.E.R. 671 | Epoxy/resin (co-resin) | | 63.38 | | | |
| Additol P-791 | Hardener | | | | 30 | 19.5 |
| Aradur 835 | Hardener | 35.03 | 25.12 | 33 | 9 | 19.5 |
| Tego AddBond LTH | Promoter | | | 5 | | |
| Benzoin | Degassing | 0.5 | 0.5 | 0.5 | 1 | 1 |
| Resiflow PL 200 | Flow | 1 | 1 | 1 | 1 | 1 |
| BYK-3941 P | Promotor | | | | 3 | 3 |
| Kronos 2300 | Pigment | 9 | 9 | 9 | 5 | 5 |
| Carbon Black FW 2 | pigment | 1 | 1 | 1 | 0.2 | 0.2 |
| | | 100 | 100 | 100 | 100 | 100 |

R Test = Customer with internal number R
B Test = Customer with internal number B
NEX = not extruded
EX = all non-curing parts of the formulation are extruded and later mixed with the Hardener as NEX

Illustrative embodiments have been described, herein above. It will be apparent to those skilled in the art that the above compositions and methods may incorporate changes and modifications without departing from the scope of this disclosure. The disclosure is therefore not limited to particular details of this disclosure and will encompass modifications and adaptations thereof within the spirit and scope of the appended claims.

1. A water-based coating for application to a substrate, the water-based coating comprising:
a. water;
b. a polyolefin, the polyolefin having a melting temperature below 100° C.;
c. a resin, the resin having a cure temperature in the range of 80° C. to 100° C. or a melting temperature in the range of 65° C. to 90° C.;
d. a hardener;
e. an optional substrate wetting agent; and
f. an optional conductive agent.

2. The water-based coating of claim 1, wherein the substrate is composed of a material selected from the group consisting of a polymer, metal, carbon fiber and/or a combination thereof.

3. The water-based coating of claim 1, wherein the substrate is selected from the group consisting of a non-conductive, low surface energy substrate, a thermoplastic olefin substrate, a resin transfer molded substrate, and a reaction injection molding substrate.

4. The water-based coating of claim 1, wherein the substrate wetting agent is present in an amount from 0.1-1.5 weight percent of the water-based coating.

5. The water-based coating of claim 1, wherein the conductive agent is present in an amount from 0.1-10 weight percent of the water-based coating.

6. The water-based coating of claim 1, wherein the polyolefin is a non-halogen modified polyolefin.

7. The water-based coating of claim 6, wherein the non-halogen modified polyolefin is a maleic anhydride-modified polyolefin.

8. The water-based coating of claim 1, wherein the polyolefin is an unmodified polyolefin.

9. The water-based coating of claim 1, wherein the polyolefin has a melting temperature in the range of 60° C. to 90° C.

10. The water-based coating of claim 1, wherein the resin is an epoxy resin.

11. The water-based coating of claim 1, wherein the resin has a cure temperature in the range of 80° C. to 90° C.

12. The water-based coating of claim 1, wherein the hardener is an amine-functional compound or an aliphatic polyanhydride wherein the hardener has a melting temperature in the range of 65° C. to 90° C.

13. The water-based coating of claim 12, wherein the amine-functional compound is selected from the group consisting of a polyamine compound, an aliphatic polyamine compound, and an aromatic amine compound.

14. A thermoplastic olefin substrate coated with the water-based coating of claim 1,
wherein the water-based coating has been cured at a temperature in the range of 60° C. to 90° C.

15. The thermoplastic olefin substrate of claim 15, wherein the water-based coating is void of extruded materials.

16. A dry, solid-powder composition for application to a substrate, the dry, solid-powder composition comprising:
a. a polyolefin, the polyolefin having a melting temperature below 100° C.;
b. a resin, the resin having a cure temperature in the range of 80° C. to 100° C.;
c. a hardener having a melting temperature in the range of 65° C. to 90° C.;
d. an optional substrate wetting agent; and
e. an optional conductive agent.

17. The dry, solid-powder composition of claim 16, wherein the polyolefin is a non-halogen modified polyolefin.

18. The dry, solid-powder composition of claim 16, wherein the polyolefin has a melting temperature in the range of 60° C. to 90° C. and the resin has a cure temperature in the range of 80° C. to 90° C.

19. The dry, solid-powder composition of claim 16, wherein the hardener is present in the composition at 12 to 30 weight percent based on the total weight of the composition and/or the hardener is an amine-functional compound or an aliphatic polyanhydride.

20. A thermoplastic olefin substrate coated with the dry, solid-powder composition of claim 16, wherein the coating of the dry, solid-powder composition has been cured at a temperature in the range of 60° C. to 90° C.
